(19) United States
(12) Patent Application Publication
(10) Pub. No.: US 2011/0261095 A1
(43) Pub. Date: Oct. 27, 2011

(54) Electronic Display Unit and Device for Actuating Pixels of a Display

(75) Inventor: Robert Missbach, Kreischa/OT Barenklause (DE)

(73) Assignee: SeeReal Technologies S.A., Munsbach (LU)

(21) Appl. No.: 12/674,688

(22) PCT Filed: Aug. 14, 2008
(86) PCT No.: PCT/EP08/60666

§ 371 Date: Feb. 23, 2010

(30) Foreign Application Priority Data
Aug. 23, 2007 (DE) 102007040712.4

(51) Int. Cl. G09G 5/02

(52) U.S. Cl. 345/698

(57) ABSTRACT

The invention relates to a device for actuating pixels of a display having a display which is divided into a plurality of clusters, at least one data driver circuit which is arranged at least one edge of the display, having at least one output for each cluster for outputting pixel actuation data, in each case one receiver circuit assigned to each cluster and having at least one input for receiving the pixel actuation data, wherein the receiver circuit is configured to actuate the respective pixel within the assigned cluster by reference to the received pixel actuation data, and in each case a wave conductor for connecting an output of the data driver circuit to the associated input of the receiver circuit.

The present invention relates to an electronic display device and to a device for controlling pixels of a display, and in particular for the fast control of pixels in a high-resolution display, in particular of a TFT display.

TFT displays are known in the prior art. The pixels in the display panel are normally controlled by a matrix of row and column lines, which is why they are generally also called matrix displays. One row is always active, and analogue values are simultaneously written to all pixels of the activated row through the column lines.

However, with increasing resolutions and refresh rates, as they are required for example by so-called holographic displays for representing holograms, these conventional display panels which are controlled through global row and column lines reach their limits, because an increase in the frequency on the column lines means that the capacitance of the column line and of the pixel TFTs (thin-film transistors) must be subjected to charge reversals in very short intervals. This is why the power loss will rise by the same degree. There is a limit defined by the impedance and capacitance of the conductor beyond which it is no longer possible to achieve a full charge reversal in the conductor in one clock cycle.

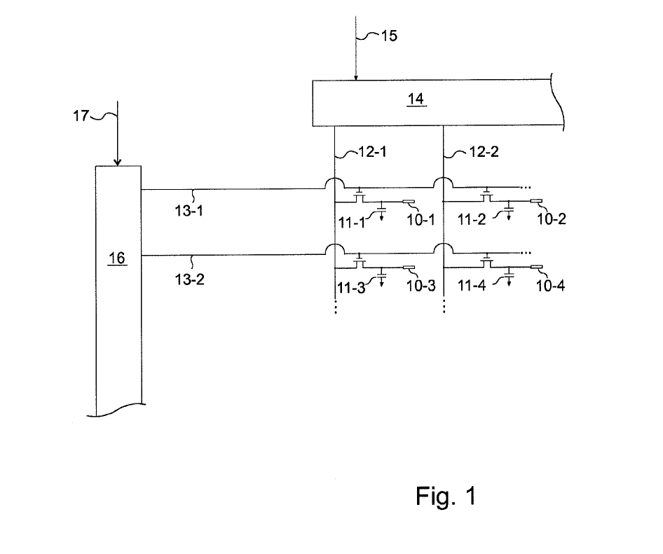

This is illustrated with the following example. Common TFT displays, which exhibit resolutions of up to 3840×2400 pixels today, can be controlled according to the aforementioned general principle with column and row drivers, as is shown schematically in FIG. 1. FIG. 1 shows four pixels 10-1, 10-2, 10-3, 10-4, which have corresponding pixel capacitances 11-1, 11-2, 11-3, 11-4, and which are controlled through the column lines 12-1, 12-2 and row lines 13-1, 13-2. The column lines are driven by an analogue multiplexer 14, which has at least one corresponding multiplexed analogue input 15. The row lines are switched by a digital shift register 16, which is controlled by a token bit for row control through the input 17.

However, such an arrangement will cause substantial problems in conjunction with future (holographic) displays with very high resolutions of more than 100 m pixels in conjunction with frame rates of more than 100 Hz. If the number of rows or the frame rate of a TFT display is increased, the control frequency on the row and column lines will go up as follows:

Control frequency=Frame rate*Number of rows (1)

While this frequency is about 72 kHz in today's panels (assuming 1,200 rows and a frame rate of 60 Hz), it could easily rise to 720 kHz in the future (assuming 4000 rows and a frame rate of 180 Hz).

As the size of the display panel is increased, the problems connected with that also grow because the length of the conductors rises accordingly. For example, if a 40-inch display panel is tiled into quarters, the length of the row lines is about 400 mm. If this quarter has 4000 rows and if the panel is operated at 180 fps, these values can hardly be realised with the common arrangement of row and column lines as shown in FIG. 1 due to the length of the conductors.

The problem in prior art devices is that the control of the pixels with a matrix of row and column lines, which is typically employed in TFT displays today, always requires a complete charge reversal in the conductors, and that this charge reversal cannot be realised in one cycle at a correspondingly high control frequency. In addition, the power loss rises to the same degree caused by the required fast charge reversal, which leads to an increased power consumption, and which requires additional means for dissipating the generated heat.

In a high-resolution display with a very large number of pixels (e.g. 16000×8000 pixels) and a frame rate of 150 Hz, as required for holographic applications, these problems become so grave that display panels with conventional control mechanisms cannot be used for such holographic purposes due to the very high switching frequencies.

It is thus the object of the present invention to provide an electronic display device and an improved way of controlling a display panel, both of which ensuring a high resolution and, simultaneously, a high frame rate.

This object is solved according to this invention by a device to claim 1 and an electronic display device to claim 21. Preferred embodiments of the invention are defined in the dependent claims.

The inventive device for controlling pixels of a display comprises a display panel which is divided into a multitude of clusters, at least one data driver circuit which is disposed on at least one edge of the display panel and which has at least one output for each cluster for outputting pixel control information, one receiver circuit per cluster with at least one input for receiving the pixel control information, where the receiver circuit is configured such to control the desired pixel within the respective cluster in accordance with the received pixel control information, and one waveguide each for connecting an output of the data driver circuit and the assigned input of the receiver circuit.

Using both a display panel which is divided into clusters and terminated waveguides to connect the data driver circuit and the receiver circuit for the respective clusters makes the complete charge reversal of global column and row lines to achieve a static condition superfluous, because the information is transported from the start to the end of the waveguide in the form of pulses, so that much higher switching frequencies can be realised and, consequently, displays with much higher resolution and frame rate can be controlled.

According to one aspect of the invention, the pixel control information which is received through the waveguides is distributed to the individual pixel with the help of a matrix of local row and column lines within the clusters, which are also called partial displays, so that accordingly fewer lines must be controlled compared to the entire display panel and that a higher refresh rate is achieved at the same control frequency.

According to a further aspect of the invention, the transistors of the receiver circuit are implemented in p-Si (poly-silicon) and distributed between the pixel transistors of the respective clusters. When using fast thin-film transistors of the p-Si type, the pixel can be controlled with the incoming pixel control information at a high frequency, which in turn results in a high refresh rate. The brightness of the display will not be reduced if the transistors are distributed as homogeneously as possible within a cluster.

Other embodiments of the invention will be described in detail in conjunction with the accompanying drawings, wherein:

FIG. 1 shows a detail of a circuit diagram of the control circuitry for controlling pixel of a display panel according to the prior art;

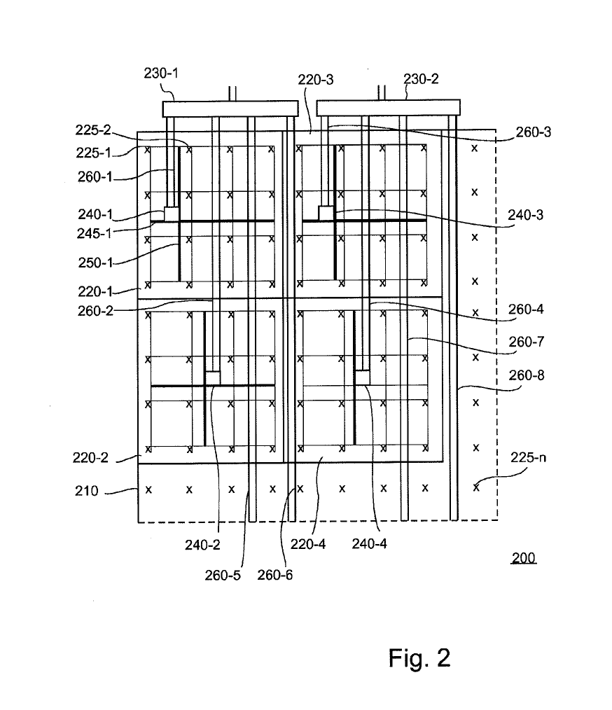

FIG. 2 is a simplified schematic diagram of a detail of the control circuitry for controlling pixel of a display panel according to an embodiment of this invention;

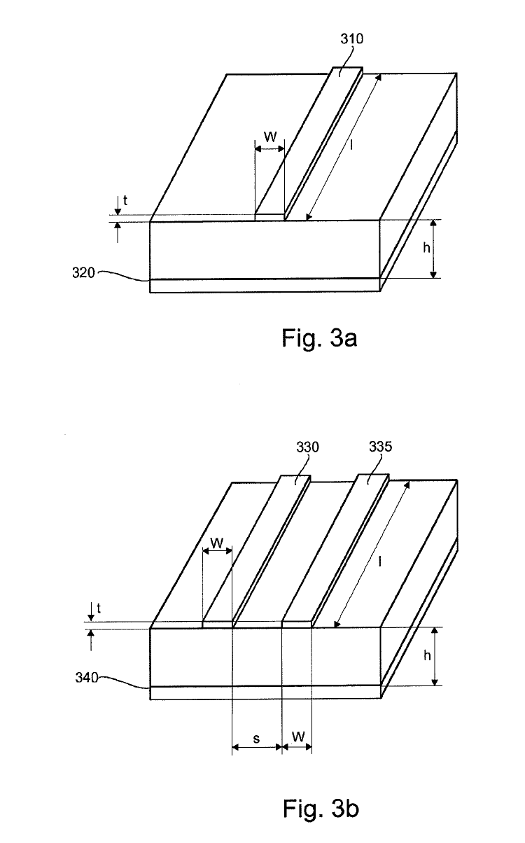

FIG. 3a shows a waveguide in the form of a single micro-strip conductor according to an embodiment of this invention; and

FIG. 3b shows a waveguide in the form of edge-coupled symmetric micro-strip conductors according to another embodiment of this invention.

FIG. 2 shows a detail of a simplified schematic diagram of a TFT display 200 with a device for controlling pixel 225-1, 225-2, . . . , 225-n of a display panel 210. According to an embodiment according to this invention, the display is divided into a multitude of partial displays called clusters, of which only four clusters 220-1, 220-2, 220-3, 220-4 are shown in the detail in FIG. 2 to illustrate the idea. It appears to a person skilled in the art that the entire TFT display is typically divided into much more clusters. An estimation of the size (i.e. the number of pixel per cluster) and thus of the number of clusters into which the entire display panel is divided will be given below. The clusters 220-1, 220-2, 220-3, 220-4 in FIG. 2 only have a size of 4×4 pixel for the sake of illustration. Typically, a cluster has more pixels; it preferably has a size of e.g. 64×64 pixels. Depending on the refresh rate and resolution, other physical forms may be preferred where the clusters have a size of 10×10 pixels to 400×400 pixels or more. According to further embodiments, the pixels are not organized in a square cluster, but rather in a rectangular, polygonal or honeycomb structure.

Data driver circuits, each of which having an input for the reception of pixel control information, are preferably disposed along one edge of the TFT display panel; in FIG. 2 the two data driver circuits 230-1, 230-2 are shown at the top edge of the panel. According to an embodiment, this input of the data driver circuits is an LVDS input which can be operated at a data rate of 1 GBit/s. The data driver circuits are realised in the form of ICs of a COG (chip on glass) type and are directly applied on the display panel.

The data driver circuits of the display panel have at least one output for each cluster for outputting pixel control information. In the embodiment illustrated in FIG. 2, there is one output per cluster, so that the data driver circuit 230-1 with its four outputs controls the pixels of four clusters, namely the clusters 220-1 and 220-2 and the two clusters below them in that column (not included in the detail shown in FIG. 2).

Each cluster is assigned with a receiver circuit with at least one input for the reception of pixel control information. In the embodiment shown in FIG. 2, the cluster 220-1 is assigned with the receiver circuit 240-1, the cluster 220-2 is assigned with the receiver circuit 240-2, the cluster 220-3 is assigned with the receiver circuit 240-3, the cluster 220-4 is assigned with the receiver circuit 240-4, and so on. The transistors of the receiver circuit are preferably realised using the p-Si technology and distributed as homogeneously as possible in the respective cluster, so that there is no or only little reduction in brightness of the display. Each receiver circuit is configured such to control the individual pixels in the respective cluster in accordance with the pixel control information which it receives from the assigned data driver circuit. In the embodiment shown in FIG. 2, this is done for the cluster 220-1 through the local row and column lines 245-1 and 250-1, and accordingly for the other clusters, so that all pixels in a cluster can be controlled by the assigned receiver circuit. The principle of controlling pixels through row and column lines, as shown in FIG. 1, is known from prior art and shall thus not be described here in more detail. However, the local row and column lines are not controlled by the data driver circuits at the edge of the panel, but by the receiver circuit in each cluster. If passive-matrix displays are used, the local row and column lines are also activated by the receiver circuit of the respective cluster, so that the desired electric field is generated at the intersection of the addressed pixel.

The individual outputs of the data driver circuit are connected to the input of the assigned receiver circuit with a waveguide, so that a terminated waveguide connection is established between an output of a data driver circuit and an input of a receiver circuit. Following the input unit, the receiver circuit comprises a receiver unit which terminates the waveguide and which receives the pixel control information, and a decoding and driver unit which decodes the pixel control information to get row and column information and which controls the local row and column lines accordingly. In the embodiment shown in FIG. 2, the waveguide 260-1 connects the data driver circuit 230-1 with the receiver circuit 240-1, the waveguide 260-2 connects the data driver circuit 230-1 with the receiver circuit 240-2, the waveguide 260-3 connects the data driver circuit 230-2 with the receiver circuit 240-3, and the waveguide 260-4 connects the data driver circuit 230-2 with the receiver circuit 240-4. The two other waveguides 260-5 and 260-6 which come from the data driver circuit 230-1 and the two waveguides 260-7 and 260-8 which come from the data driver circuit 230-2 run to the receiver circuits of clusters which are not shown in the detail of FIG. 2. The waveguides which are shown in FIG. 2 are indicated to be differential waveguides, which are capable of transmitting information at 25 MBit/s according to an embodiment.

If according to an embodiment multiple waveguides are provided for transmitting the pixel control information between the data driver circuit and the receiver circuit of a cluster, the data rate can be increased accordingly. This can be preferable if particularly large clusters are chosen with a great number of pixels to be controlled, and if a sufficient number of pixel columns are available for the arrangement of waveguides to connect the clusters, so that then multiple (e.g. two, three, four or even more) waveguides are used in parallel to control a cluster. According to a further embodiment, where large clusters and multiple waveguides to control these clusters are used, it is preferable to distribute multiple receiver circuits across the cluster to receive the pixel control information through at least one waveguide and to control a part of the pixels of the respective cluster.

The conductor which is used for the transmission of the pixel control information from the data driver circuit across the panel to the receiver circuit of the respective cluster is preferably designed in the form of a waveguide, because the signals can then be transmitted without the need of a complete charge reversal in the entire conductor, thus realising a high transmission frequency.

However, since waveguides cannot used as normal row or column lines just like that, because then very many transistors had to be driven by one conductor, which would cause an inhomogeneous wave impedance, only one receiver is preferably disposed at the end of the conductor, namely the input of the receiver circuit that terminates the waveguide. It is thus preferable according to this invention to divide the display panel into clusters and to transmit the information through at least one waveguide each directly from the data driver circuit at the edge of the panel to the cluster. Within a cluster, the receiver unit of the receiver circuit receives the information and hands it over to the decoding and driver unit, which de-serializes it and distributes it to the individual pixels of this cluster through local row and column lines. Alternatively, the decoding and driver unit of the receiver circuit controls the desired pixel directly.

The design of the conductor in the form of a waveguide is preferably chosen such that there is an almost constant wave impedance over the entire length of the conductor. In this case, pulses which are supplied to the input side of the conductor run along the conductor without any reflection.

It is further preferable to additionally terminate the waveguide with a resistor which corresponds with the wave impedance, so that no reflection occur at that point either. The energy of the pulses is absorbed by the terminal resistor instead. According to an embodiment, this terminal resistor is integrated into the receiver unit of the receiver circuit.

The use of waveguides has the advantage that in order to transmit a signal from the beginning to the end of the conductor it is not the entire length of the conductor that needs to be subjected to a charge reversal to achieve a static level, but instead the pulses are transported unidirectionally from a sender (output of the data driver circuit) to the receiver (input of the receiver circuit), very similar to optical waveguides or radio transmission.

The design of a waveguide determines an attenuation (ratio of the signal amplitudes at input and output) which is proportional to the length of the conductor, and a velocity of propagation which is reduced in relation to the velocity of light. The signal transit time is calculated based on that velocity and the length of the conductor. Since it is not the entire conductor which needs to be brought to a static level, the driver power can be reduced and higher data rates become possible.

FIGS. 3a and 3b show possible embodiments of the waveguide. FIG. 3a shows a waveguide in the form of a single micro-strip with a conductor 310 on an insulated grounded surface 320. FIG. 3b shows a waveguide in the form of an edge-coupled symmetric micro-strip of two differential conductors 330, 335 which are arranged at little distance to each other on a grounded surface 340.

In contrast to ordinary conductors, which must be subjected to frequent charge reversals to be able to transmit information, the use of waveguides according to this invention has among others in particular the following advantages: substantially higher data rates and lower driver power, thus less power loss and heat generation. The transistors of the receiver circuit are preferably of a p-Si type and distributed across the respective cluster. The switching speed of the transistors which can be achieved today when high-quality poly-silicon (p-Si) materials (e.g. CGS) are used for the TFTs, currently only allows frequencies of up to about 25 MHz. However, if semiconductor materials are developed to realise TFTs with higher switching speeds, the data rate per conductor can be increased even further.

The embodiment of the edge-coupled symmetric micro-strip conductors is used in conjunction with standards such as LVDS, DVI, PCIe; it is characterised by low emission and good resistance to the injection of disturbing signals. This allows the voltage difference to be lowered to 300-800 mV, which in turn leads to a very low power consumption.

A further characteristic of designing the conductor from the data driver circuit to the receiver circuit in the form of a waveguide is that signal clocking is required to synchronise the data reception in the receiver circuit. According to an embodiment, at least one clocking line is provided to transmit a synchronous clock signal to data driver circuits and receiver circuits. Preferably one waveguide per cluster serves as clocking line.

According to another embodiment, the data driver circuit is configured such to embed clocking signals into the pixel control information, and the receiver circuits are configured such to resume the clocking signals.

The pixel control information can generally be transmitted in the form of either analogue values or bit-serial data. According to an embodiment, the data driver circuit is configured such to transmit the pixel control information in the form of analogue data through the waveguides to the receiver circuits. For this, the levels of the analogue values are preferably shifted up by the amount of attenuation caused by the length of the conductor in order to write the correct values to all pixels throughout the display panel.

According to another embodiment, the data driver circuit is configured such to transmit the pixel control information in the form of bit-serial digital data through the waveguides to the receiver circuits. The receiver circuits are configured such to de-serialize the received pixel control information in order to control the pixels. Since the same clock rate is required during serialization in the sender (data driver circuit) and during de-serialization in the receiver (receiver circuit), this clock rate is preferably either provided through separate lines or embedded into the data stream, e.g. by way of 8/10 encoding.

According to another embodiment, a D/A converter is integrated into the receiver circuit, so that a digital-analogue (D/A) conversion of the incoming pixel control information is performed by the receiver circuit in the cluster. In doing so, it is achieved that the D/A conversion of the pixel control information is relocated from the data driver circuit to the receiver circuit and that the pixel control information is transmitted as digital data up to the receiver circuit. A D/A conversion will be necessary if the TFTs for the pixels are controlled with analogue signals.

In addition to the conductor pairs shown in FIG. 2, ground conductor, operating voltage conductor and, if necessary, clocking signal lines must be routed to the individual computing units.

The following exemplary information is given with respect to the estimation of the waveguide parameters for single micro-strip conductors and edge-coupled symmetric micro-strip conductors; it shall not be construed to limit the extent of sought protection in any way.

Single micro-strip (one conductor on the grounded surface):
Conductor track width: 15 μm
Conductor track thickness: 5 μm Cu
Grounded surface at a distance of 20 μm, dielectric with a relative permittivity of 4
Distance between adjacent conductor tracks: 35 μm
Calculated wave impedance at 25 MHz: 75 Ω
Attenuation: 0.008 dB/mm (1.6 dB at 200 mm)
Edge-coupled symmetric micro-strip:
Conductor track width: 10 μm
Conductor track thickness: 3 μm Cu
Grounded surface at a distance of 0.25 mm, dielectric with a relative permittivity of 4
Distance between the conductor tracks of a pair: 10 μm
Distance between the conductor tracks of adjacent pairs: 30 μm
Calculated wave impedance at 25 MHz: 136 Ω
Attenuation (odd mode): 0.0173 dB/mm (3.46 dB at 200 mm)

When dimensioning the panels and the waveguides which run on it, it must be noted that cross-talking between the waveguides must be prevented, which is why two single conductors or conductor pairs must have a certain distance to each other, which is much larger than the distance to the grounded surface (h), the width (w) and, in pairs, the distance (s); see also FIGS. 3a and 3b. Due to the small pixel pitch, this requirement makes high demands on the general circuit design of the display panel, and particularly on routing the waveguides. In an embodiment where the single micro-strip conductor is used as waveguide, there is the risk of cross-talking between adjacent conductors because of the long parallel conductors. According to an embodiment, this risk is prevented or at least minimised by arranging short and long conductors alternately.

According to another embodiment, the data driver circuit is configured such to adjust the driver power for the pixel control information depending on the cross-talking between adjacent waveguides. Cross-talking is preferably pre-computed and, based on the result of that computation, the output pulses of the data driver circuit are compensated accordingly.

According to another embodiment, the signal quality in a conductor is improved in that in subsequent identical values of pixel control information the driver power is reduced.

As regards the shape and mutual arrangement of the clusters, the clusters are preferably arranged on the TFT display panel without gaps, so that a homogeneous distribution of pixels and thus a homogeneous image is achieved for the entire display. The clusters do not necessarily have to be of square or rectangular shape, as shown in the embodiment illustrated in FIG. 2. Other embodiments which also allow gapless arrangement provide hexagonal or honeycomb-shaped clusters on the TFT panel, so that adjacent clusters are arranged at a vertical or horizontal offset. Thanks to this offset arrangement, the waveguides which connect the clusters can be distributed more homogeneously across the entire panel.

As long as a display technology is chosen for the TFT panel which can implement sufficiently fast TFTs (e.g. made of p-Si), the device according to this invention can be realised in conjunction with various types of displays. Embodiments thus include electronic display devices or image display devices where the display is provided in the form of an OLED, MO or LCD panel.

Electronic display devices according to an embodiment comprise a TFT display with a device for controlling pixels according to this invention, a housing and further control circuitry, including an interface for controlling the display device and, typically, a power supply unit. According to an embodiment, the display is an active-matrix display with local row and column lines for controlling the pixels within the clusters, said display only differing from outside for the user in that is has a higher resolution and a higher refresh rate.

According to further embodiments, the display is either an active-matrix or a passive-matrix display. In an active-matrix display, each individual pixel has an active pixel cell which is controlled through the row and column lines. In a passive-matrix display, the pixels are only formed at intersecting points of the row and column lines in that at the intersecting points of the activated row and column lines an electric field is generated which effects for example in a liquid-crystal display a reorientation of the rods.

According to another embodiment, the display of the electronic display device is a high-resolution display which is suitable for displaying holographic representations.

In order to estimate the cluster size according to an embodiment, one waveguide is first provided per pixel column of the display panel. The maximum possible refresh rate is then derived from the switching frequency of the transistors divided by the number of rows in the display. The estimations are for example based on a maximum switching frequency of 25 MHz for poly-silicon, so that in an embodiment with 4000 rows a frame rate of 25*10̂6/4000=6250 Hz can be achieved theoretically. The number of pixels in the cluster must in that case be at least the number of rows, which would mean a size of approximately 64×64 pixels in a square cluster.

If the frame rate is lower, an embodiment with larger clusters is preferably used, so that fewer waveguides are required and that not every pixel column has a waveguide at its edge. According to an embodiment, these “gaps” are preferably used to route ground conductors, operating voltage conductors or clock signal lines.

In order to be able to write a large amount of data to the panel in high-resolution displays, a large number of specially adapted integrated COG data driver circuits (data driver ICs) are provided on the panel according to an embodiment. According to an embodiment, 80 data drive ICs with 10 inputs at 1 GBit/s and 400 outputs at 25 MBit/s each are used for this. The transistors of the receiver circuit are preferably also made using the COG technology.

In the embodiment with a maximum frame rate of 6 kHz at an operating voltage of 3 V, a power loss of 400 W must be considered in total for all COG data driver ICs, which are preferably disposed at the edge of the panel. This would mean 5 W power loss for each of the 80 data driver ICs. For such a high frame rate, the ICs are thus required to have a relatively large surface area in order to be able to remove that power loss. In addition, measures for dissipating the generated heat, i.e. cooling means, must preferably be provided at such high frequencies. For example, so-called heat pipes are used for heat dissipation which remove the heat from the small area at the edge of the panel.

According to an embodiment with a frame rate of 300 Hz, the power loss of the data driver ICs and panel has a magnitude of about 40 W, so that no additional measures must be taken for heat dissipation or cooling.

In addition to the implementation of the receiver circuit and further parts of the TFT display using the p-Si technology, as described above, these parts can alternatively be implemented using other semiconductor technologies, such as organic TFTs, poly-SiGe, monocrystalline silicon or GaAs according to other embodiments. Poly-silicon (p-Si) here stands for the various possible sub-types, such as ULTPS, LPSOI, LTPS, HPS, CGS and others. The characteristics of the respective semiconductor technologies and their use with view to the requirements of this invention are apparent to a person skilled in the art and do therefore not require any further explanation here.

Moreover, any combination of the features and embodiments disclosed in this description and in the accompanying Figures which are considered to be part of the invention by a person skilled in the art shall be included in the scope of this invention even though they are not explicitly described in that particular combination.

1. Device for controlling pixels of a display, comprising:
a display panel which is divided into a multitude of clusters;
at least one data driver circuit which is disposed on at least one edge of the display panel and which has at least one output for each cluster for outputting pixel control information;
one receiver circuit per cluster with at least one input for receiving the pixel control information, where the receiver circuit is configured such to control the desired pixel within the respective cluster in accordance with the received pixel control information; and
one waveguide each for connecting an output of the data driver circuit and the assigned input of the receiver circuit.

2. Device according to claim 1, where each pixel can be controlled by a local row and column line, and where the receiver circuit is configured such to control the respective local row and column line of at least one pixel within the respective cluster in accordance with the received pixel control information.

3. Device according to one of the preceding claims, where the waveguides are designed in the form of micro-strip conductors which are arranged on an insulated grounded surface.

4. Device according to one of claim 1 or 2, where the waveguides are designed in the form of edge-coupled symmetric micro-strip conductors.

5. Device according to one of the preceding claims, where short and long waveguides are arranged alternately across the display.

6. Device according to one of the preceding claims, where the data driver circuit is configured such to reduce the driver power for the pixel control information if subsequent values are identical.

7. Device according to one of the preceding claims, where the data driver circuit is configured such to adjust the driver power for the pixel control information depending on the cross-talking between adjacent waveguides.

8. Device according to one of the preceding claims, where the data driver circuit is configured such to transmit the pixel control information in the form of analogue data through the waveguides to the receiver circuits.

9. Device according to one of the preceding claims, where the data driver circuit is configured such to transmit the pixel control information in the form of bit-serial digital data through the waveguides to the receiver circuits, and where the receiver circuits are configured such to de-serialize the received pixel control information for controlling the pixels.

10. Device according to one of the preceding claims, further comprising at least one clocking line for providing a synchronous clock signal to data driver circuits and receiver circuits.

11. Device according to claim 10, where one waveguide per cluster serves as clocking line.

12. Device according to claim 10, where the data driver circuit is configured such to embed clocking signals into the pixel control information, and the receiver circuit is configured such to resume the clocking signals.

13. Device according to one of the preceding claims, where the receiver circuit comprises a D/A converter which converts the received pixel control information into analogue signals for an analogue control of the respective pixel.

14. Device according to one of the preceding claims, where the data driver circuit and/or receiver circuit is realised using the chip-on-glass technology (COG) on the display panel.

15. Device according to one of the preceding claims, where the transistors of the receiver circuit are made using the p-Si-technology and distributed across the respective cluster.

16. Device according to one of the preceding claims, where the clusters are arranged next to each other without gaps on the display.

17. Device according to one of the preceding claims, where the display panel is divided into square, rectangular, hexagonal or honeycomb-shaped clusters.

18. Device according to one of the preceding claims, where the display is a TFT display.

19. Device according to one of the preceding claims, where the display is an OLED display, an MO display or an LCD display.

20. Device according to one of the preceding claims, where the display comprises a high-resolution display panel which is suitable for displaying holographic representations.

21. Electronic display device, comprising the device according to one of the preceding claims.

22. Electronic display device according to claim 21, where the display is an active-matrix display with row and column lines for controlling the pixels within the clusters.

23. Electronic display device according to claim 22, where the display is a passive-matrix display with row and column lines for activating the pixels within the clusters.
